(19) United States
(12) Patent Application Publication
(10) Pub. No.: US 2015/0264585 A1
(43) Pub. Date: Sep. 17, 2015

(54) TERMINAL APPARATUS

(71) Applicant: SHARP KABUSHIKI KAISHA, Osaka-shi, Osaka (JP)

(72) Inventors: Hiroki Takahashi, Osaka-shi (JP); Jungo Goto, Osaka-shi (JP); Osamu Nakamura, Osaka-shi (JP); Kazunari Yokomakura, Osaka-shi (JP); Yasuhiro Hamaguchi, Osaka-shi (JP)

(73) Assignee: SHARP KABUSHIKI KAISHA, Osaka-shi, Osaka (JP)

(21) Appl. No.: 14/432,935

(22) PCT Filed: Sep. 30, 2013
(86) PCT No.: PCT/JP2013/076589

§ 371 Date: Apr. 1, 2015

(30) Foreign Application Priority Data
Oct. 2, 2012 (JP) 2012-220321

(51) Int. Cl. H04W 16/32; H04L 27/26; H04W 36/22

(52) U.S. Cl. CPC H04W 16/32; H04W 36/22; H04L 27/26

(57) ABSTRACT

A terminal uses different access methods between when the terminal transmits a signal to a pico base station and when the terminal uses a macro base station as a receiving station without increasing the amount of control information to be transmitted from the base station to the terminal. A terminal apparatus of the present invention communicates with a macro base station that forms a first cell or a pico base station that forms a second cell smaller than the first cell. Upon reception of an instruction to communicate with the pico base station from the macro base station (S5), the terminal apparatus communicates with the pico base station using a second access method different from the access method used in the communication with the macro base station (S10).

### TECHNICAL FIELD

The present invention relates to a terminal apparatus connectable to both a macro base station and a pico base station.

### BACKGROUND ART

Transmission bands are increasingly widened in wireless communication systems due to increase in demands for large volume communication in recent years and this causes a shortage of available wireless frequency resources. It is effective to increase the communication capacity with a Multiple-Input Multiple-Output (MIMO) transmission technology in order to improve the frequency use efficiency using the limited wireless frequency resources. Orthogonal Frequency Division Multiplexing (OFDM) having high affinity with the MIMO technology is adopted as an access method various wireless standards including in wireless local area network (LAN) and Worldwide Interoperability for Microwave Access (WiMAX).

In cellular communication, arrangement of new base stations (pico base stations, low power nodes (LPNs)) having communication areas smaller than those of macro base stations in cells is discussed, in addition to a base station configuration in related art in which the macro base stations of similar scales form the corresponding cells so as to cover different communication areas (NPL 1). The formation of the new cells allows the areas covered by the respective base stations to be split to increase the communication capacity (also referred to as cell splitting gain or area splitting gain) (cells formed by the macro base stations are hereinafter referred to as macro cells and cells formed by the pico base stations are hereinafter referred to as small cells). For example, when many terminal apparatuses exist in a macro cell having small cells formed therein, the macro base station instructs each terminal apparatus in each small cell to connect to the corresponding pico base station. Connection of the terminal apparatus that has received the instruction to the pico base station allows the load of the macro base station to be off-loaded to the pico base station, thereby increasing the transmission opportunities of all the terminal apparatuses in the macro cell.

Since the terminal apparatuses in a cellular system generally transmit signals to distant base stations, compared with the wireless LAN, etc., high transmission power is required of the terminal apparatuses to meet desired reception power in the base stations. Accordingly, high-capacity power amplifiers are required while the performance of the power amplifiers of the terminal apparatuses for which reduction in size is required is limited. An access method having a low Peak-to-Average Power Ratio (PAPR) as much as possible is required for transmission signals in order to keep the linearity of the power amplification. Practically, Discrete Fourier Transform Spread Orthogonal Frequency Division Multiplexing (DFT-S-OFDM) (also referred to as Single Carrier Frequency Division Multiple Access (SC-FDMA)) is adopted as an uplink access method in Long Term Evolution (LTE) (also referred to as The Third Generation Partnership Project (3GPP) Release 8), which is a cellular communication standard. DFT-S-OFDM is known as having excellent PAPR characteristics and is a single-carrier transmission method. However, it is easy to keep the linearity of the amplifiers also in the terminal apparatuses in the small cells which have small communication areas and for which high power is not required. Accordingly, it is possible to use methods, such as OFDM, having high transmission rates, as in the wireless LAN. In contrast, it is difficult to use methods, such as OFDM, for which the high performance of the amplifiers is required in uplink transmission for the macro base stations having large communication areas, as described above.

### CITATION LIST

### Non Patent Literature

NPL 1: 3GPP R1-120398

### SUMMARY OF INVENTION

### Technical Problem

The terminal apparatuses connectable to both the macro base stations and the pico base stations are required to support both the access methods in the related art and new access methods and switch the access methods to be used in response to instructions from the base stations. In this case, it is necessary for the base stations to notify the terminal apparatuses of the uplink access methods to cause a problem of increased overheads.

In order to resolve the above problems, it is an object of the present invention to provide a terminal apparatus and a communication method capable of, when the terminal transmits a signal to a pico base station, using an access method that is different from the one when the terminal uses a macro base station as the receiving station without increasing the amount of control information to be transmitted from the base station to the terminal.

### Solution to Problem

(1) In order to achieve the above object, the present invention takes the following measures. A terminal apparatus of the present invention communicates with a macro base station that forms a first cell or a pico base station that forms a second cell smaller than the first cell. Upon reception of an instruction to communicate with the pico base station from the macro base station, the terminal apparatus communicates with the pico base station using a second access method different from the access method used in the communication with the macro base station.

(2) A terminal apparatus of the present invention communicates with a macro base station that forms a first cell or a pico base station that forms a second cell smaller than the first cell. The terminal apparatus communicates with the macro base station using a first access method and communicates with the pico base station using a second access method different from the first access method when an instruction to switch to the pico base station for communication is received from the macro base station.

(3) A terminal apparatus of the present invention communicates with a base station that forms a first cell and a second cell smaller than the first cell. The terminal apparatus communicates with the base station over the first cell using a first access method and communicates with the base station using a second access method different from the first access method when an instruction to communicate over the second cell is received from the base station.

(4) In the terminal apparatus of the present invention, the first access method is a single-carrier method and the second access method is a multi-carrier method.

(5) In the terminal apparatus of the present invention, the first access method is Discrete Fourier Transform Spread Orthogonal Frequency Division Multiplexing (DFT-S-OFDM) and the second access method is Orthogonal Frequency Division Multiplexing (OFDM).

(6) A communication method of the present invention is for a terminal apparatus communicating with a macro base station that forms a first cell or a pico base station that forms a second cell smaller than the first cell. Upon reception of an instruction to communicate with the pico base station from the macro base station, the communication with the pico base station is performed using a second access method different from the access method used in the communication with the macro base station.

(7) A communication method of the present invention is for a terminal apparatus communicating with a base station that forms a first cell and a second cell smaller than the first cell. The communication with the base station is performed over the first cell using a first access method and the communication with the base station is performed using a second access method different from the first access method when an instruction to communicate over the second cell is received from the base station.

### Advantageous Effects of Invention

The use of the present invention allows the terminal, when the terminal transmits a signal to the pico base station, to use an access method that is different from the one when the terminal uses the macro base station as the receiving station without increasing the amount of control information to be transmitted from the base station to the terminal, thereby improving the throughput.

### BRIEF DESCRIPTION OF DRAWINGS

FIG. 1 illustrates an exemplary configuration of a wireless communication system according to a first embodiment of the present invention.

FIG. 2 is a sequence chart for describing an exemplary operation of each apparatus according to the first embodiment of the present invention.

FIG. 3 is a schematic block diagram illustrating a configuration of a terminal apparatus 5 according to the first embodiment of the present invention.

FIG. 4 is a schematic block diagram illustrating an internal configuration of an uplink signal generating unit 107 according to the first embodiment of the present invention.

FIG. 5 is a schematic block diagram illustrating a configuration of a macro base station 1 according to the first embodiment of the present invention.

FIG. 6 is a schematic block diagram illustrating an internal configuration of an uplink signal processing unit 313 according to the first embodiment of the present invention.

FIG. 7 is a schematic block diagram illustrating a configuration of a pico base station 3 according to the first embodiment of the present invention.

FIG. 8 illustrates an exemplary configuration of a wireless communication system according to a second embodiment of the present invention.

FIG. 9 is a sequence chart for describing an operation of each apparatus according to the second embodiment of the present invention.

FIG. 10 is a schematic block diagram of a terminal apparatus 603 according to the second embodiment of the present invention.

FIG. 11 is a schematic block diagram illustrating an internal configuration of an uplink signal generating unit 707 according to the second embodiment of the present invention.

FIG. 12 is a schematic block diagram of a base station 601 according to the second embodiment of the present invention.

### DESCRIPTION OF EMBODIMENTS

Embodiments of the present invention will herein be described with reference to the attached drawings. DFT-S-OFDM (sometimes also referred as SC-FDMA) and OFDM are exemplified as access methods in the embodiments described below. However, the present invention is not limited to these access methods and the advantages of the present invention are not lost even when other access methods are used.

### First Embodiment

### <<System>>

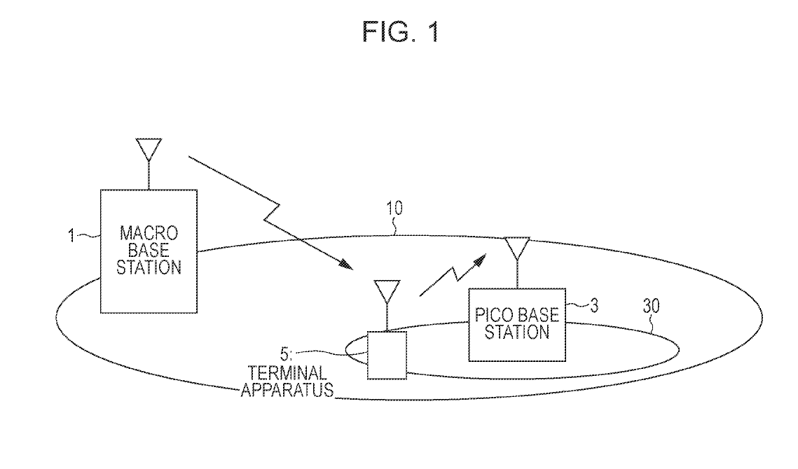

FIG. 1 illustrates an exemplary configuration of a wireless communication system according to a first embodiment of the present invention. The wireless communication system according to the present embodiment is a mobile communication system including a macro base station 1, a pico base station 3, and a terminal apparatus 5. The macro base station 1 forms a macro cell 10 covering a communication area larger than that of the pica base station 3. The pico base station 3 forms a pico cell 30 covering a limited communication area so as to be overlapped with part of the communication area of the macro base station 1. However, the numbers of the macro base station 1, the pico base station 3, and the terminal apparatus 5 are only examples and the present invention is applicable to a system including multiple macro base stations 1, multiple pico base stations 3, and multiple terminal apparatuses 5.

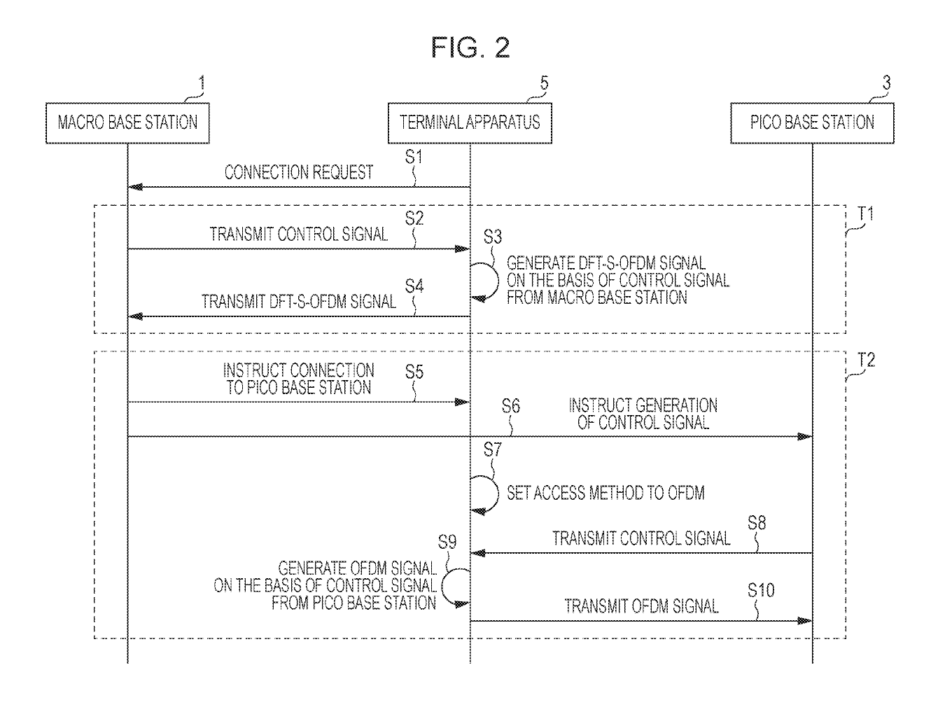

FIG. 2 is a sequence chart for describing an exemplary operation of each apparatus according to the first embodiment of the present invention. At start of communication, the terminal apparatus 5 submits a connection request to the macro base station 1 (Step S1). The macro base station 1, which has received the request, answers the request. When the macro base station 1 is capable of receiving a signal, the macro base station 1 transmits a control signal including a parameter used in transmission of a signal from the terminal apparatus 5 to the macro base station 1 to the terminal apparatus 5 (Step S2). The terminal apparatus 5, which has received the control signal, generates a DFT-S-OFDM signal on the basis of the control signal (Step S3). The terminal apparatus 5 transmits the DFT-S-OFDM signal to the macro base station 1 (Step S4).

If an arbitrary condition is met in the macro base station 1 (for example, if the number of the terminal apparatuses 5 connected to the macro base station 1 reaches a threshold value), the macro base station 1 is capable of instructing the terminal apparatus 5 to connect to the pico base station 3 (Step S5). The macro base station 1 is capable of instructing the pico base station 3 to connect to the terminal apparatus 5 (Step S6). The terminal apparatus 5, which has received the connection instruction (Step S5), sets OFDM, instead of DFT-S-OFDM, as the access method in the transmission to the pico base station 3 (Step S7). The pico base station 3, which has received the connection instruction (Step S6), transmits a control signal including a parameter used in transmission of a signal to the pico base station 3 (Step S8). The terminal apparatus 5, which has received the control signal from the pico base station 3, generates an OFDM signal on the basis of the control signal (Step S9). The terminal apparatus 5 transmits the OFDM signal to the pico base station 3 (Step S10).

As described above, the terminal apparatus 5 is capable of using an appropriate access method without receiving an instruction about the access method from the macro base station 1 or the pico base station 3 by implicitly determining the access method depending on the base station to which the terminal apparatus 5 is to be connected. However, although a case (Step T1) is described in the sequence chart in FIG. 2 in which the macro base station 1, which has received the connection request from the terminal apparatus 5 (Step S1), communicates with the terminal apparatus 5 at least once, a case (Step T2) is also included in the present invention in which the macro base station 1, which has received the connection request (Step S1), transmits the request to connect to the pico base station 3 (Step S5) and the pico base station 3 communicates with the terminal apparatus 5 from the beginning.

### <<Terminal Apparatus 5>>

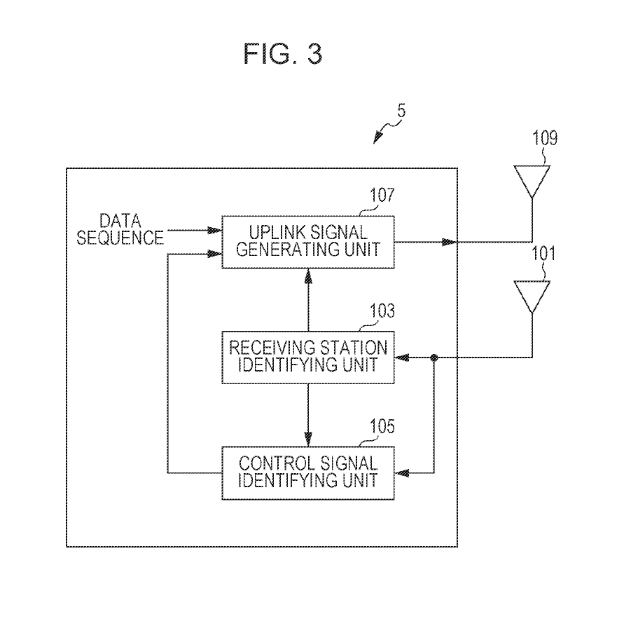

FIG. 3 is a schematic block diagram illustrating a configuration of the terminal apparatus 5 according to the first embodiment of the present invention. The terminal apparatus 5 includes a receive antenna 101, a receiving station identifying unit 103, a control signal identifying unit 105, an uplink signal generating unit 107, and a transmit antenna 109. The receive antenna 101 receives a signal from an arbitrary base station (the macro base station 1 or the pico base station 3). The receiving station identifying unit 103 detects an instruction signal from the macro base station 1 to instruct the terminal apparatus 5 to transmit a signal to the pico base station 3 from the signals received through the receive antenna 101. Upon reception of the instruction signal, the receiving station identifying unit 103 notifies the control signal identifying unit 105 and the uplink signal generating unit 107 that the receiving station of the uplink transmission is set to the pico base station 3 that is specified.

The control signal identifying unit 105 extracts a control signal specifying MCS and an allocated frequency used for an uplink signal for the terminal apparatus 5 from the signals that have been transmitted from the macro base station 1 or the pica base station 3 and that have been received through the receive antenna 101 and supplies the extracted control signal to the uplink signal generating unit 107. Here, the control signal identifying unit 105 extracts the control signal transmitted from the macro base station 1 when the notification that the receiving station is set to the pico base station 3 is not received from the receiving station identifying unit 103. The control signal identifying unit 105 extracts the control signal transmitted from the specified pico base station 3 when the instruction that the receiving station is set the pico base station 3 is received from the receiving station identifying unit 103. The uplink signal generating unit 107 processes a transmission data sequence to generate the uplink signal and transmits the uplink signal through the transmit antenna 109. Modulation and Coding Schemes (MCS) and information about the allocated frequency used in the processing are supplied from the control signal identifying unit 105 as control information and information indicating whether the receiving station is the macro base station 1 or the pico base station 3 is supplied from the receiving station identifying unit 103.

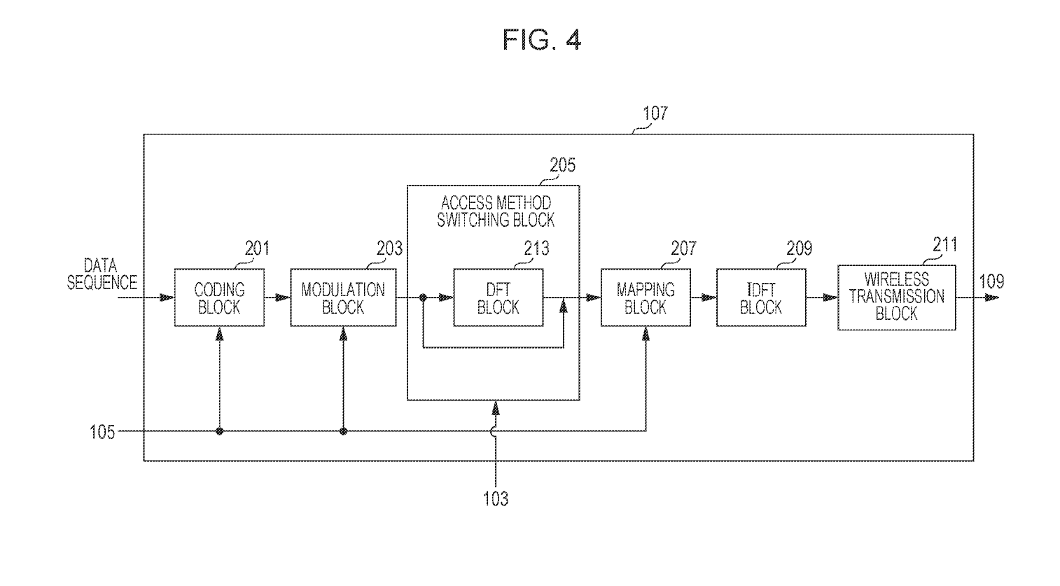

FIG. 4 is a schematic block diagram illustrating an internal configuration of the uplink signal generating unit 107 according to the first embodiment of the present invention. The uplink signal generating unit 107 includes a coding block 201, a modulation block 203, an access method switching block 205, a mapping block 207, an IDFT block 209, and a wireless transmission block 211. The coding block 201 receives a data sequence composed of information bits. The coding block 201 applies error correction coding using a turbo code or a Low Density Parity Check (LDPC) code depending on coding rate information indicated by the control signal supplied from the control signal identifying unit 105 and supplies a bit sequence subjected to the coding to the modulation block 203. Interleave may be performed in which the order of the bits is changed in the coding block. The modulation block 203 performs a modulation process to Quadrature Phase Shift Keying (QPSK), 16-ary Quadrature Amplitude Modulation (16QAM), or the like depending on modulation method information indicated by the control information supplied from the control signal identifying unit 105 and supplies a modulation signal resulting from the modulation to the access method switching block 205.

The access method switching block 205 includes a DFT block 213. The access method switching block 205 changes the processing in accordance with the information about the receiving station supplied from the receiving station identifying unit 103 in FIG. 3. Specifically, when the receiving station is the macro base station 1, the access method switching block 205 inputs the modulation signal supplied from the modulation block 203 into the DFT block 213 and performs Discrete Fourier Transform (DFT) in the DFT block 213 to convert a time domain signal into a frequency domain signal. Then, the access method switching block 205 supplies the frequency domain signal to the mapping block 207. In contrast, when the receiving station is the pico base station 3, the access method switching block 205 supplies the modulation signal supplied from the modulation block 203 to the mapping block 207 without processing.

The mapping block 207 arranges the signal supplied from the access method switching block 205 in a frequency band used for transmission in accordance with the allocated frequency information indicated in the control information supplied from the control signal identifying unit 105 in FIG. 3 and supplies the signal to the IDFT block 209. The IDFT block 209 performs Inverse DFT (IDFT) to the frequency domain signal supplied from the mapping block 207 to convert the frequency domain signal into the time domain signal. Then, the IDFT block 209 supplies the time domain signal to the wireless transmission block 211. The wireless transmission block 211 adds a cyclic prefix (CP) (a signal resulting from copying part at the back side of the IDFT symbol) to the front side of the IDFT symbol in the supplied time domain signal, converts the digital signal into an analog signal through digital to analog (D/A) conversion, and performs up-conversion. Then, the wireless transmission block 211 supplies a transmission signal subjected to the processing to the transmit antenna 109. However, although the receive antenna 101 and the transmit antenna 109 are separate blocks in the terminal apparatus 5 illustrated in FIG. 3, one antenna may be commonly used as the receive antenna 101 and the transmit antenna 109 as long as the one antenna has the functions of the respective blocks.

The terminal apparatus 5 described above with reference to FIG. 3 and FIG. 4 is capable of confirming whether the instruction to connect to the pico base station 3 is issued from the macro base station 1 and is capable of performing data transmission using the DFT-S-OFDM method when the receiving station is set to the macro base station 1 and performing data transmission using the OFDM method when the receiving station is set to the pico base station 3.

### <<Macro Base Station 1>>

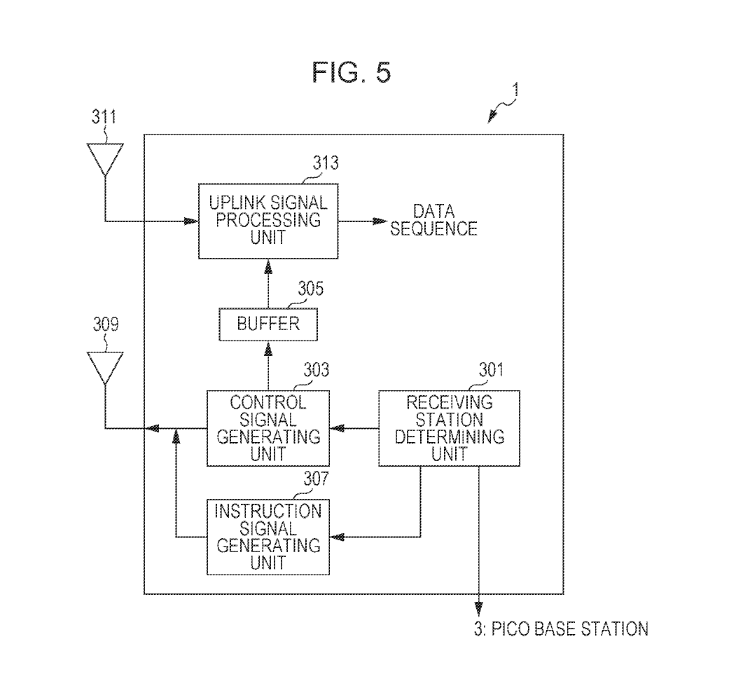

FIG. 5 is a schematic block diagram illustrating a configuration of the macro base station 1 according to the first embodiment of the present invention. The macro base station 1 includes a receiving station determining unit 301, a control signal generating unit 303, a buffer 305, an instruction signal generating unit 307, a transmit antenna 309, a receive antenna 311, and an uplink signal processing unit 313.

The receiving station determining unit 301 determines the own station (the macro base station 1) or the pico base station 3 existing in the corresponding communication area to be the receiving station of the terminal apparatus 5 existing in the communication area covered by the macro base station 1. In the selection of the receiving station, for example, if the traffic of the communication with the own station (the macro base station 1) or the number of the terminal apparatuses 5 connected to the macro base station 1 is larger than or equal to a threshold value, the receiving station of the terminal apparatus 5 near the pico base station 3 is set to the pica base station 3. However, the selection criterion does not limit the present invention and other criteria may be used. For example, an instruction to constantly connect the terminal apparatus 5 existing near the pico base station 3 to the pico base station 3 may be issued. The receiving station determining unit 301 supplies information about the terminal apparatus 5 the receiving station of which is determined to be the own station (the macro base station 1) to the control signal generating unit 303. The receiving station determining unit 301 supplies information about the terminal apparatus 5 the receiving station of which is determined to be the pico base station 3 and information about the pico base station 3 to which the terminal apparatus 5 is to be connected to the instruction signal generating unit 307. When the instruction to connect the terminal apparatus 5 to the pico base station 3 is issued, the receiving station determining unit 301 notifies the pico base station 3 of the presence of the terminal apparatus 5. The pico base station 3 may be notified of the presence of the terminal apparatus 5 in a wired manner or via wireless communication.

The control signal generating unit 303 generates the control signal to be transmitted to the terminal apparatus 5 the receiving station of which is determined to be the own station (the macro base station 1) by the receiving station determining unit 301 and supplies the control signal to the transmit antenna 309. The control signal includes the allocated frequency information and MCS and these pieces of information are determined by scheduling for a terminal apparatus group the receiving station of which is the macro base station 1. The allocated frequency information and the information about MCS are temporarily stored in the buffer 305 and are supplied to the uplink signal processing unit 313 upon reception of an up signal transmitted on the basis of the these pieces of information from the terminal apparatus 5. The instruction signal generating unit 307 generates the signal to instruct the terminal apparatus 5 indicated in the information supplied from the receiving station determining unit 301 to connect to the pico base station 3. The instruction signal may be one-bit information instructing the connection to the pico base station 3 or may be an identifier to identify the pico base station 3 to which the terminal apparatus 5 is to be connected.

The control signal generated in the control signal generating unit 303 is transmitted to the terminal apparatus 5 the receiving station of which is the macro base station 1 via the transmit antenna 309, and the instruction signal generated in the instruction signal generating unit 307 is transmitted to the terminal apparatus 5 the receiving station of which is the pico base station 3 via the transmit antenna 309. The receive antenna 311 receives the up signal transmitted from the terminal apparatus 5 illustrated in FIG. 3 or the up signals transmitted from multiple terminal apparatuses 5 similar to the terminal apparatus 5 in FIG. 3. The uplink signal processing unit 313 extracts the signal transmitted to the macro base station 1 from the signals received through the receive antenna 311 for every terminal apparatus 5, which is a transmission station, performs a demodulation process to the signal, and outputs the signal as a data sequence.

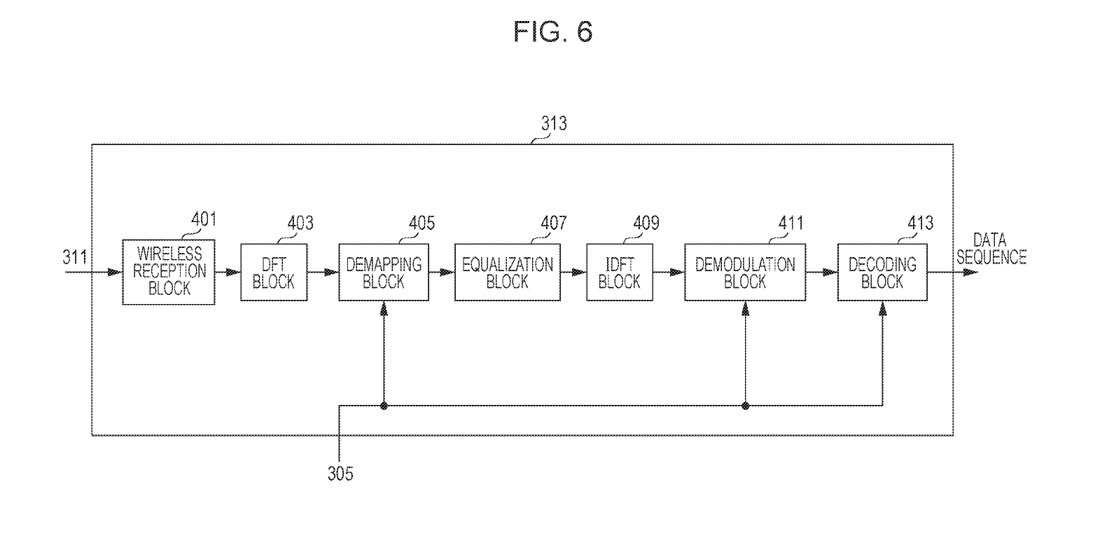

FIG. 6 is a schematic block diagram illustrating an internal configuration of the uplink signal processing unit 313 according to the first embodiment of the present invention. The uplink signal processing unit 313 includes a wireless reception block 401, a DFT block 403, a demapping block 405, an equalization block 407, an IDFT block 409, a demodulation block 411, and a decoding block 413. The wireless reception block 401 performs down-conversion to the reception signal received through the receive antenna 311 in FIG. 5, converts the analog signal into a digital signal through analog to digital (A/D) conversion, and removes the CP. The wireless reception block 401 supplies the signal subjected to the processing to the DFT block 403. The DFT block 403 converts the time domain signal, which is supplied from the wireless reception block 401, into the frequency domain signal with DFT and supplies the frequency domain signal to the demapping block 405. The demapping block 405 receives the allocated frequency information indicating the band used by the terminal apparatus 5 which has transmitted the signal from the buffer 305 in FIG. 5. The demapping block 405 extracts a signal within the frequency band indicated by the allocated frequency information from the signals supplied from the DFT block 403 and supplies the extracted signal to the equalization block 407.

The equalization block 407 performs equalization to correct distortion on a channel. The IDFT block 409 converts the frequency domain signal into the time domain signal with IDFT and supplies the time domain signal to the demodulation block 411. The demodulation block 411 receives information indicating MCS used by the terminal apparatus 5 which has transmitted the signal from the buffer 305 in FIG. 5. The demodulation block 411 converts the reception symbol in the signal supplied from the IDFT block 409 into bits on the basis of the modulation method indicated by MCS. The decoding block 413 receives the information indicating MCS used by the terminal apparatus 5 which has transmitted the signal from the buffer 305 in FIG. 5. The decoding block 413 applies error correction decoding based on the coding rate indicated by MCS to the input from the demodulation block 411 to acquire a transmission data bit sequence. However, when the signals are simultaneously received from the multiple terminal apparatuses 5 in the macro base station 1 illustrated in FIG. 5, the processes performed by the demapping block 405, the equalization block 407, the IDFT block 409, the demodulation block 411, and the decoding block 413 may be performed in parallel for every terminal apparatus 5.

As described above, the macro base station 1 illustrated in FIG. 5 is capable of instructing the terminal apparatus 5 existing in the area covered by the macro base station 1 to connect to the pico base station 3, as needed.

### <<Pico Base Station 3>>

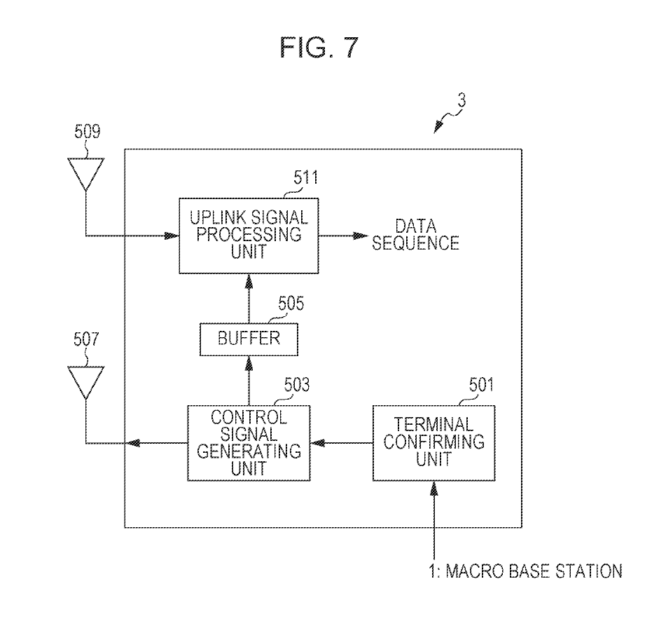

FIG. 7 is a schematic block diagram illustrating a configuration of the pico base station 3 according to the first embodiment of the present invention. The pico base station 3 includes a terminal confirming unit 501, a control signal generating unit 503, a buffer 505, a transmit antenna 507, a receive antenna 509, and an uplink signal processing unit 511. The pico base station 3 is connected to the macro base station 1 having the area part of which is overlapped with the area covered by the pico base station 3 in a wired manner or wirelessly. The terminal confirming unit 501 stores information about the terminal apparatus 5 the receiving station of which is the pico base station 3, which is notified from the receiving station determining unit 301 in the macro base station 1 to which the pico base station 3 is connected. The information is supplied to the control signal generating unit 503 at timing when the control information is generated. The control signal generating unit 503 generates the control information to be transmitted to each terminal apparatus 5 the receiving station of which is the pico base station 3 and transmits the control signal to the terminal apparatus 5 through the transmit antenna 507. The control information includes the allocated frequency information and the information about MCS, etc. and these pieces of information are determined by scheduling for a terminal apparatus group the receiving station of which is the pico base station 3. The allocated frequency information and the information about MCS, etc. are temporarily stored in the buffer 505 and are supplied to the uplink signal processing unit 511 upon reception of the uplink signal transmitted on the basis of these pieces of information from the terminal apparatus 5.

The receive antenna 509 receives the uplink signal transmitted from the terminal apparatus 5 illustrated in FIG. 3 or the uplink signals transmitted from multiple terminal apparatuses 5 similar to the terminal apparatus 5 in FIG. 3. The uplink signal processing unit 511 extracts the signal transmitted to the pico base station 3 from the signals received through the receive antenna 509 for every terminal apparatus 5, which is the transmission station, performs the demodulation process to the signal, and outputs the signal as a data sequence.

As described above, the pico base station 3 illustrated in FIG. 7 is capable of allocating the band to the terminal apparatus 5 for which the connection instruction has been issued from the macro base station 1 and receiving the uplink signal transmitted from the terminal apparatus 5 using the band.

The mode is indicated in the present embodiment in which, in the terminal apparatus 5 transmitting the uplink signal to the macro base station 1 or the pico base station 3, the signal is transmitted to the macro base station 1 using the DFT-S-OFDM method and the signal is transmitted using the OFDM method when the instruction to transmit the signal to the pico base station 3 is received from the macro base station 1. The terminal apparatus 5 is capable of appropriately switching the access method with such an operation without receiving the instruction about the access method from the base station, thereby improving the throughput.

### Second Embodiment

The mode is indicated in the first embodiment in which, when the terminal apparatus 5 is instructed from the macro base station 1 to connect to the pico base station 3, the terminal apparatus 5 implicitly uses a different access method. A mode is indicated in a second embodiment in which a terminal apparatus transmitting a signal to a base station that manages multiple communication areas (cells or sectors) changes the access method in response to an instruction to connect a different cell from the base station.

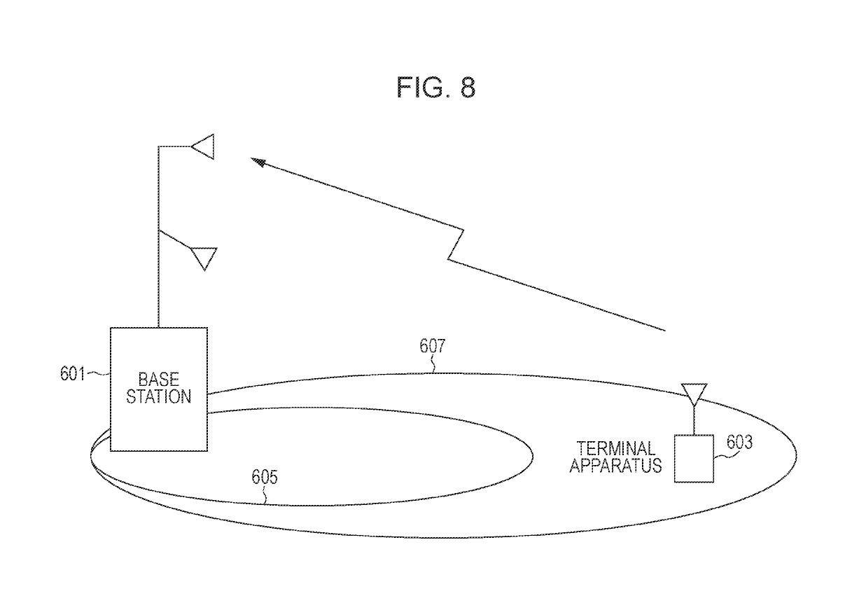

FIG. 8 illustrates an exemplary configuration of a wireless communication system according to the second embodiment of the present invention. The wireless communication system according to the present embodiment is a mobile communication system including a base station 601 and a terminal apparatus 603. The base station 601 has two receive antennas having different directivities. The base station 601 manages multiple cells, such as a short distance cell 605 and a long distance cell 607, having different distances from the base station 601 with the two antennas and performs independent wireless resource management for every cell (such processing is sometimes referred to as vertical sectorization or vertical cell splitting). However, each receive antenna may be composed of multiple antennas and the reception signals may be combined with each other in consideration of the difference in phase between the antennas to realize the directivity.

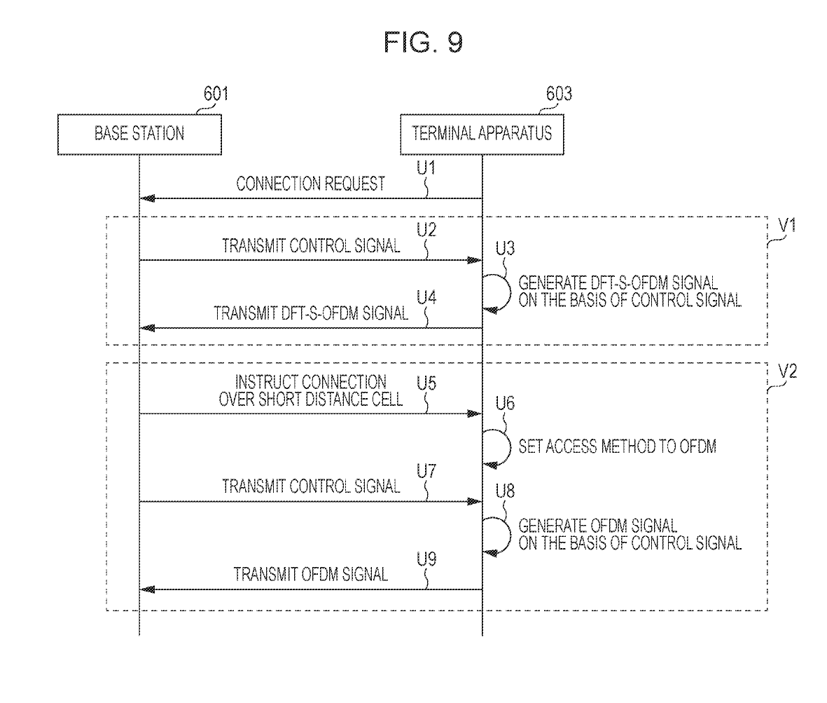

FIG. 9 is a sequence chart for describing an operation of each apparatus according to the second embodiment of the present invention. At start of communication, the terminal apparatus 603 submits a connection request to the base station 601 (Step U1). The base station 601, which has received the request, answers the request. When the base station 601 instructs the uplink transmission over the maximum cell covered by the base station 601, that is, over the long distance cell 607, the base station 601 transmits a control signal including a parameter used in transmission of a signal to the base station 601 to the terminal apparatus 603 (Step U2). The terminal apparatus 603, which has received the control signal, generates a DFT-S-OFDM signal on the basis of the control signal (Step U3). The terminal apparatus 603 transmits the DFT-S-OFDM signal to the base station 601 (Step U4).

If an arbitrary condition is met in the base station 601 (for example, if the position of the terminal apparatus 603 connected to the base station 601 is within the short distance cell 605), the base station 601 is capable of instructing the terminal apparatus 603 of connection over the short distance cell 605 (Step U5). The terminal apparatus 603, which has received the connection instruction (Step U5), sets OFDM, instead of DFT-S-OFDM, as the access method in the transmission to the base station 601 (Step U6). The base station 601 transmits the control signal including a parameter used in transmission of a signal to the base station 601 (Step U7). The terminal apparatus 603, which has received the control signal from the base station 601, generates an OFDM signal on the basis of the control signal (Step U8). The terminal apparatus 603 transmits the OFDM signal to the base station 601 (Step U9).

However, although a case (Step V1) is described in the sequence chart in FIG. 9 in which the base station 601, which has received the connection request from the terminal apparatus 603 (Step U1), receives the signal from the terminal apparatus 603 over the long distance cell 607, a case (Step V2) is also included in the present invention in which the base station 601, which has received the connection request (Step U1), transmits the connection instruction over the short distance cell 605 (Step U5) and receives a signal from the terminal apparatus 603 over the short distance cell 605 from the beginning.

Although the case in which the difference in time exists between the connection instruction over the short distance cell (Step U5) and the transmission of the control signal (Step U7) is described with reference to FIG. 9, the connection instruction and the control signal may be simultaneously transmitted from the base station 601 to the terminal apparatus 603. In this case, the switching of the access method to OFDM (Step U6) is performed after Steps U5 and U7.

As described above, when the base station 601 manages the short distance cell 605 and the long distance cell 607, the terminal apparatus 603 belonging to the short distance cell 605 is closer to the base station 601, compared with the case in which the terminal apparatus 603 belongs to the long distance cell 607. Accordingly, the transmission power in the uplink transmission is capable of being suppressed. Consequently, it is possible to apply the access method, such as OFDM, as in the terminal apparatus 603 belonging to the small cell described above in Background Art.

The base station 601 according to the present embodiment notifies the terminal apparatus 603 of a cell identifier used to determine whether the terminal apparatus 603 belongs to the short distance cell 605 or the long distance cell 607. The terminal apparatus 603 changes the access method to be used in accordance with the identifier. The block configuration of the apparatuses is illustrated below provided that the terminal apparatus 603 performs the uplink transmission using the OFDM method when the terminal apparatus 603 belongs to the short distance cell 605 and using the DFT-S-OFDM method when the terminal apparatus 603 belongs to the long distance cell 607.

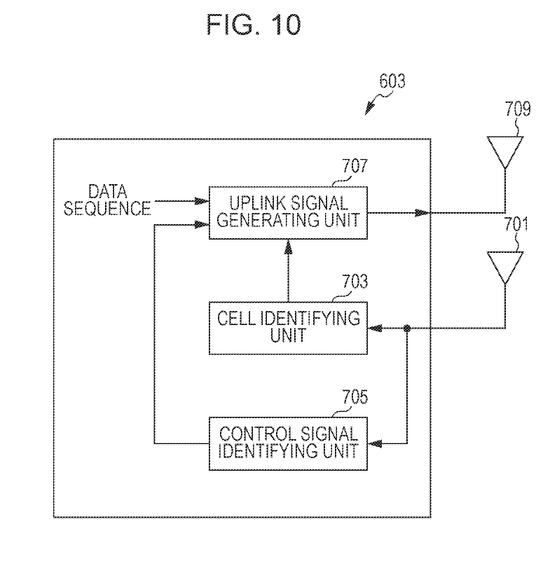

FIG. 10 is a schematic block diagram of the terminal apparatus 603 according to the second embodiment of the present invention. The terminal apparatus 603 includes a receive antenna 701, a cell identifying unit 703, a control signal identifying unit 705, an uplink signal generating unit 707, and a transmit antenna 709. The receive antenna 701 receives a downlink signal transmitted from the base station 601 described below. The cell identifying unit 703 extracts the cell identifier used to determine whether the cell to which the terminal apparatus 603 belongs is the short distance cell 605 or the long distance cell 607 from the signal received through the receive antenna 701 and supplies the information to the uplink signal generating unit 707. The control signal identifying unit 705 extracts the control signal specifying MCS and the allocated frequency used in the uplink transmission for the terminal apparatus 603 from the signals that have been received through the receive antenna 701 and supplies the extracted control signal to the uplink signal generating unit 707. However, when the resource, the spread code, and so on used for the control information in the short distance cell 605 are different from those used for the control information in the long distance cell 607, the cell identifier extracted by the cell identifying unit 703 may be supplied to the control signal identifying unit 705 and the control signal identifying unit 705 may extract the control information on the basis of the identifier.

The uplink signal generating unit 707 processes the transmission data sequence to generate the uplink signal and transmits the uplink signal through the transmit antenna 709. The information about MCS and the allocated frequency used in the processing are supplied from the control signal identifying unit 705 to the uplink signal generating unit 707 as the control information and the cell identifier is supplied from the cell identifying unit 703 to the uplink signal generating unit 707.

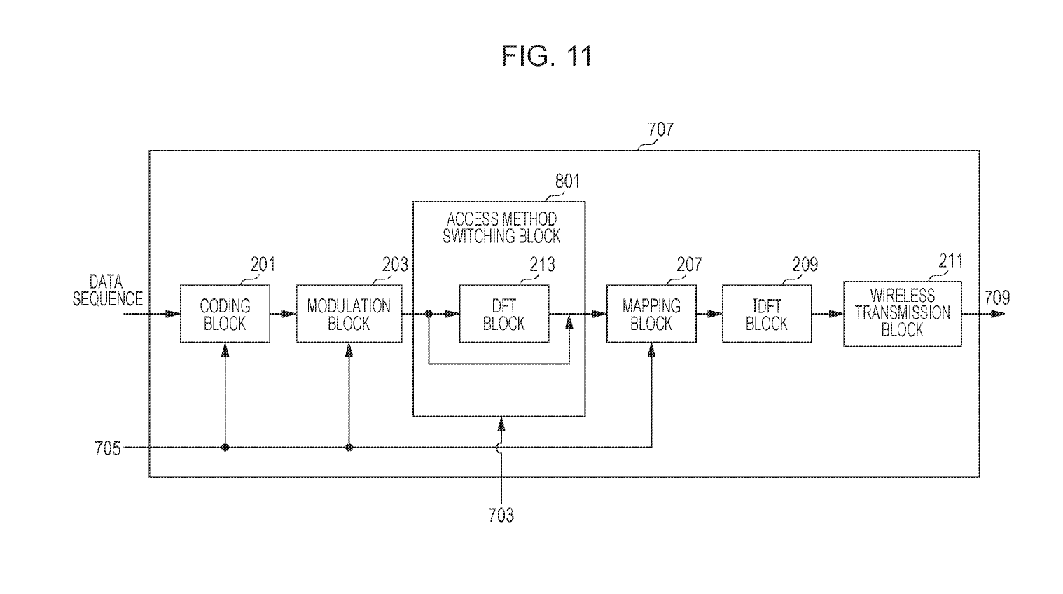

FIG. 11 is a schematic block diagram illustrating an internal configuration of the uplink signal generating unit 707 according to the second embodiment of the present invention. Although the uplink signal generating unit 707 has the same block configuration as that of the uplink signal generating unit 107 in FIG. 4, the uplink signal generating unit 707 differs from the uplink signal generating unit 107 in that the access method switching block 205 is replaced with an access method switching block 801. The uplink signal generating unit 707 differs from the uplink signal generating unit 107 in that information input into the access method switching block 801 is not the information about the receiving station but the cell identifier supplied from the cell identifying unit 703. The same reference numeral is used in FIG. 11 to identify the same block as that in the access method switching block 205. A description of such a block is omitted herein.

The access method switching block 801 includes the DFT block 213. The access method switching block 801 changes the processing in accordance with the content of the cell identifier supplied from the cell identifying unit 703 in FIG. 10. Specifically, when the cell identifier indicates that the cell to which the terminal apparatus 603 belongs is the long distance cell 607, the access method switching block 801 inputs the modulation signal supplied from the modulation block 203 into the DFT block 213 and performs DFT in the DFT block 213 to convert the time domain signal into the frequency domain signal. Then, the access method switching block 801 supplies the frequency domain signal to the mapping block 207. In contrast, when the cell identifier indicates that the cell to which the terminal apparatus 603 belongs is the short distance cell 605, the access method switching block 801 supplies the modulation signal supplied from the modulation block 203 to the mapping block 207 without processing.

The terminal apparatus 603 described above with reference to FIG. 10 and FIG. 11 is capable of determining whether the cell to which the terminal apparatus 603 belongs is the short distance cell 605 or the long distance cell 607 and is capable of performing data transmission using the DFT-S-OFDM method when the cell to which the terminal apparatus 603 belongs is the long distance cell 607 and using the OFDM method when the cell to which the terminal apparatus 603 belongs is the short distance cell 605.

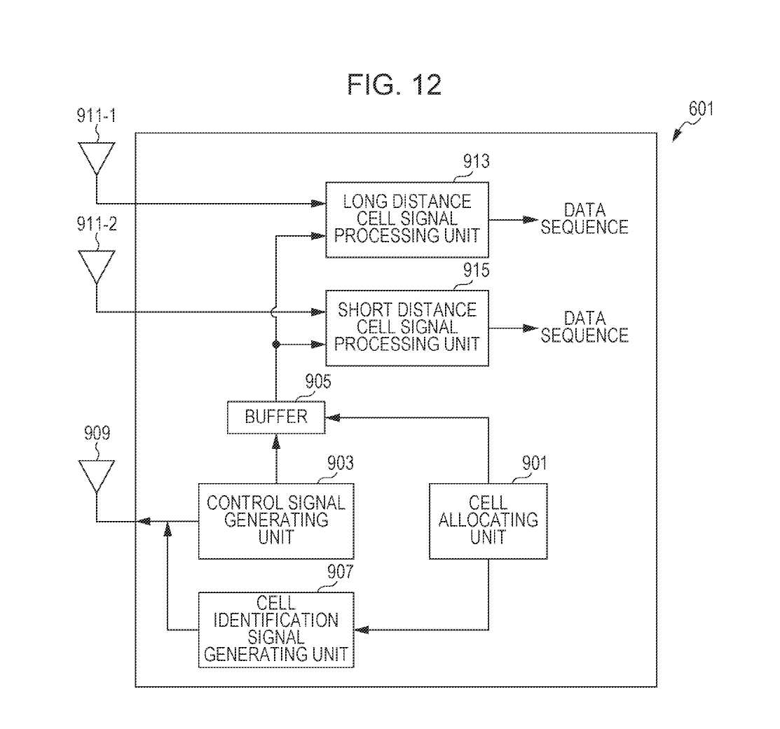

FIG. 12 is a schematic block diagram of the base station 601 according to the second embodiment of the present invention. The base station 601 includes a cell allocating unit 901, a control signal generating unit 903, a buffer 905, a cell identification signal generating unit 907, a transmit antenna 909, receive antennas 911-1 to 911-2, a long distance cell signal processing unit 913, and a short distance cell signal processing unit 915. The cell allocating unit 901 allocates one or more terminal apparatuses 603 connected to the base station 601 to the long distance cell 607 or the short distance cell 605. The allocation method is desirably determined on the basis of positional information about the terminal. Reception power of the connection request signal transmitted from each terminal, identification of the position of each terminal with Global Positioning System (GPS), etc. may be used for the allocation. The cell allocating unit 901 supplies cell information about each terminal apparatus 603 (information indicating the short distance cell 605 or the long distance cell 607) to the buffer 905 and the cell identification signal generating unit 907.

The control signal generating unit 903 generates the control signal to be transmitted to the terminal apparatus 603 the receiving station of which is the base station 601 and supplies the control signal to the transmit antenna 909. The control signal includes the allocated frequency information and MCS and these pieces of information are determined by scheduling for a terminal apparatus group the receiving station of which is the base station 601. The allocated band information and the information about MCS are input into the buffer 905. The buffer 905 temporarily stores the cell information supplied from the cell allocating unit 901 and the control information supplied from the control signal generating unit 903. Upon reception of the uplink signal transmitted on the basis of these pieces of information, the buffer 905 supplies the control signal for the terminal apparatus 603 the cell information about which indicates the long distance cell 607 to the long distance cell signal processing unit 913 and supplies the control signal for the terminal apparatus 603 the cell information about which indicates the short distance cell 605 to the short distance cell signal processing unit 915. The cell identification signal generating unit 907 generates a cell identification signal used to notify each terminal apparatus 603 of the cell information about each terminal apparatus 603 supplied from the cell allocating unit 901. The control signal generated by the control signal generating unit 903 and the cell identification signal generated by the cell identification signal generating unit 907 are transmitted to the corresponding terminal apparatus 603 via the transmit antenna 909.

The receive antennas 911-1 to 911-2 each receive the uplink signal transmitted from the terminal apparatus 603 illustrated in FIG. 10 or the uplink signals transmitted from multiple terminal apparatuses 603 similar to the terminal apparatus 603 in FIG. 10. However, each receive antenna has the directivity. The uplink signal received from the terminal apparatus 603 belonging to the long distance cell 607 is received through the receive antenna 911-1 and is supplied to the long distance cell signal processing unit 913. The uplink signal received from the terminal apparatus 603 belonging to the short distance cell 605 is received through the receive antenna 911-2 and is supplied to the short distance cell signal processing unit 915. The long distance cell signal processing unit 913 extracts the signal transmitted to the base station 601 from the signals received through the receive antenna 911-1 for every terminal apparatus 603, which is the transmission station, performs a reception process to the DFT-S-OFDM signal, and outputs the signal as a data sequence. The short distance cell signal processing unit 915 extracts the signal transmitted to the base station 601 from the signals received through the receive antenna 911-2 for every terminal apparatus 603, which is the transmission station, performs the reception process to the OFDM signal, and outputs the signal as a data sequence.

The mode is described in the present embodiment in which, in the terminal apparatus 603 transmitting the uplink signal to the base station 601 which manages the multiple cells including the long distance cell 607 and the short distance cell 605, the signal is transmitted using the DFT-S-OFDM method when the terminal apparatus 603 belongs to the long distance cell 607 and the signal is transmitted using the OFDM method when the terminal apparatus 603 belongs to the short distance cell 605. Since the terminal apparatus 603 is capable of using a transmission method appropriate for the distance to the base station 601 without specification of the access method from the base station 601 in the present embodiment, it is possible to improve the throughput.

(1) The present embodiment may adopt the following aspects. Specifically, a terminal apparatus of the present invention communicates with a macro base station that forms a first cell or a pico base station that forms a second cell smaller than the first cell. Upon reception of an instruction to communicate with the pico base station from the macro base station, the terminal apparatus communicates with the pico base station using a second access method different from the access method used in the communication with the macro base station.

With the above configuration, since the terminal apparatus communicates with the pico base station using the second access method different from the first access method used in the communication with the macro base station upon reception of the instruction to communicate with the pico base station from the macro base station, the terminal apparatus is capable of switching from the macro base station to the pico base station for communication using the second access method without increasing the amount of control information. As a result, it is possible to improve the throughput.

(2) A terminal apparatus of the present invention communicates with a macro base station that forms a first cell or a pico base station that forms a second cell smaller than the first cell. The terminal apparatus communicates with the macro base station using a first access method and communicates with the pico base station using a second access method different from the first access method when an instruction to switch to the pico base station for communication is received from the macro base station.

With the above configuration, the terminal apparatus communicates with the macro base station using the first access method and communicates with the pica base station using the second access method different from the first access method when the instruction to switch to the pico base station for communication is received from the macro base station. Accordingly, the terminal apparatus is capable of implicitly switching the base station used in the communication and switching the access method. As a result, since the amount of control information is not increased, it is possible to improve the throughput.

(3) A terminal apparatus of the present invention communicates with a base station that forms a first cell and a second cell smaller than the first cell. The terminal apparatus communicates with the base station over the first cell using a first access method and communicates with the base station using a second access method different from the first access method when an instruction to communicate over the second cell is received from the base station.

With the above configuration, the terminal apparatus communicates with the base station over the first cell using the first access method while the terminal apparatus communicates with the base station using the second access method different from the first access method when the instruction to communicate over the second cell is received from the base station. Accordingly, the terminal apparatus is capable of communicating with the base station over the second cell using the second access method without increasing the amount of control information. As a result, it is possible to improve the throughput.

(4) In the terminal apparatus of the present invention, the first access method is a single-carrier method and the second access method is a multi-carrier method.

With the above configuration, since the first access method is the single-carrier method, it is possible to perform the communication having excellent PAPR characteristics. Since the second access method is the multi-carrier method, it is possible to perform the communication at high transmission rate.

(5) In the terminal apparatus of the present invention, the first access method is Discrete Fourier Transform Spread Orthogonal Frequency Division Multiplexing (DFT-S-OFDM) and the second access method is Orthogonal Frequency Division Multiplexing (OFDM).

With the above configuration, since the first access method is DFT-S-OFDM, it is possible to perform the communication having excellent PAPR characteristics. Since the second access method is OFDM, it is possible to perform the communication at high transmission rate.

(6) A communication method of the present invention is for a terminal apparatus communicating with a macro base station that forms a first cell or a pico base station that forms a second cell smaller than the first cell. Upon reception of an instruction to communicate with the pico base station from the macro base station, the communication with the pico base station is performed using a second access method different from the access method used in the communication with the macro base station.

With the above configuration, since the communication with the pico base station is performed using the second access method different from the access method used in the communication with the macro base station upon reception of the instruction to communicate with the pico base station from the macro base station, it is possible to switch from the macro base station to the pico base station for communication using the second access method without increasing the amount of control information. As a result, it is possible to improve the throughput.

(7) A communication method of the present invention is for a terminal apparatus communicating with a base station that forms a first cell and a second cell smaller than the first cell. The communication with the base station is performed over the first cell using a first access method and the communication with the base station is performed using a second access method different from the first access method when an instruction to communicate over the second cell is received from the base station.

With the above configuration, since the communication with the base station is performed over the first cell using the first access method and the communication with the base station is performed using the second access method different from the first access method when the instruction to communicate over the second cell is received from the base station, it is possible to communicate with the base station over the second cell using the second access method without increasing the amount of control information. As a result, it is possible to improve the throughput.

Programs running on the terminal apparatuses 5 and 603, the macro base station 1, and the LPN control a central processing unit (CPU) and so on so as to realize the functions of the embodiments according to the present invention (programs to cause a computer to function). The information processed in these apparatuses is temporarily stored in a random access memory (RAM) in the processing, is subsequently stored in various read only memories (ROMs) and a hard disk drive (HDD), and is read out, modified, and/or written by the CPU, as needed. The programs may be stored in any of recording media including a semiconductor medium (for example, a ROM or a non-volatile memory card), an optical recording medium (for example, a digital versatile disk (DVD), a magneto-optical disk (MO), a mini disc (MD), a compact disc (CD), or a Blu-ray disc (BD)), or a magnetic recording medium (for example, a magnetic tape or a flexible disk).

Execution of the programs that are loaded not only realizes the functions of the above embodiment but also may realize the functions of the present invention by cooperative processing with an operating system (OS) or other application programs on the basis of instructions from the programs. In distribution of the programs to the market, the programs that are stored in a portable recording medium may be distributed or the programs may be transferred to a server computer connected via a network, such as the Internet. In this case, a storage unit in the server computer is also included in the present invention.

Part or all of the terminal apparatuses 5 and 603, the macro base station 1, and the LPN in the above embodiments may be realized as large scale integration (LSI), which is typically an integrated circuit. The functional blocks in the terminal apparatuses 5 and 603, the macro base station 1, and the LPN may be individually cut into chips or part or all of the functional blocks may be integrated to be cut into chips. The integrated circuit is not limitedly realized by the LSI and may be realized by a dedicated circuit or a general-purpose processor. When an integrated circuit technology with which the LSI is replaced appears owing to the progress in the semiconductor technology, an integrated circuit produced with the technology may be used.

While the embodiments of the present invention are described in detail with reference to the drawings, it will be clear that specific configurations are not limited to the above embodiments and that designs and so on may be included in the claims without departing from the true spirit and scope of the present invention. Although the present invention is preferably used for a mobile communication system using a cellular phone apparatus as a mobile station apparatus, the present invention is not limited to the system.

### REFERENCE SIGNS LIST

1 macro base station
3 pico base station
5 terminal apparatus
1 macro cell
30 pico cell
101 receive antenna
103 receiving station identifying unit
105 control signal identifying unit
107 uplink signal generating unit
109 transmit antenna
201 coding block
203 modulation block
205 access method switching block
207 mapping block
209 IDFT block
211 wireless transmission block
213 DFT block
301 receiving station determining unit
303 control signal generating unit
305 buffer
307 instruction signal generating unit
309 transmit antenna
311 receive antenna
313 uplink signal processing unit
401 wireless reception block
403 DFT block
405 demapping block
407 equalization block
409 IDFT block
411 demodulation block
413 decoding block
501 terminal confirming unit
503 control signal generating unit
505 buffer
507 transmit antenna
509 receive antenna
511 uplink signal processing unit
601 base station
603 terminal apparatus
605 short distance cell
607 long distance cell
701 receive antenna
703 cell identifying unit
705 control signal identifying unit
707 uplink signal generating unit
709 transmit antenna
801 access method switching block
901 cell allocating unit
903 control signal generating unit
905 buffer
907 cell identification signal generating unit
909 transmit antenna
911-1, 911-2 receive antenna
913 long distance cell signal processing unit
915 short distance cell signal processing unit

1. A terminal apparatus communicating with a macro base station that forms a first cell or a pico base station that forms a second cell,
wherein the terminal apparatus uses different access methods for transmission of a data signal between when an instruction to transmit the data signal to the macro base station is received from the macro base station and when an instruction to transmit the data to the pico base station is received from the macro base station.

2. A terminal apparatus communicating with a macro base station that forms a first cell or a pico base station that forms a second cell,
wherein the terminal apparatus communicates with the macro base station using a first access method and communicates with the pico base station using a second access method different from the first access method when an instruction to switch to the pico base station for communication is received from the macro base station.

3. A terminal apparatus communicating with a base station that forms a first cell and a second cell,
wherein the terminal apparatus communicates with the base station over the first cell using a first access method and communicates with the base station using a second access method different from the first access method when an instruction to communicate over the second cell is received from the base station.

4. The terminal apparatus according to claim 2,
wherein the first access method is a single-carrier method and the second access method is a multi-carrier method.

5. The terminal apparatus according to claim 2,
wherein the first access method is Discrete Fourier Transform Spread Orthogonal Frequency Division Multiplexing (DFT-S-OFDM) and the second access method is Orthogonal Frequency Division Multiplexing (OFDM).

6. The terminal apparatus according to claim 3,
wherein the first access method is a single-carrier method and the second access method is a multi-carrier method.

7. The terminal apparatus according to claim 3,
wherein the first access method is Discrete Fourier Transform Spread Orthogonal Frequency Division Multiplexing (DFT-S-OFDM) and the second access method is Orthogonal Frequency Division Multiplexing (OFDM).

8. The terminal apparatus according to claim 4,
wherein the first access method is Discrete Fourier Transform Spread Orthogonal Frequency Division Multiplexing (DFT-S-OFDM) and the second access method is Orthogonal Frequency Division Multiplexing (OFDM).
